(19) United States
(12) Patent Application Publication
(10) Pub. No.: US 2025/0209686 A1
(43) Pub. Date: Jun. 26, 2025

(54) METHOD, APPARATUS, DEVICE, AND STORAGE MEDIUM FOR IMAGE PROCESSING

(71) Applicants: Beijing Zitiao Network Technology Co., Ltd., Haidian District (CN); Lemon Inc., Grand Cayman (KY)

(72) Inventors: Zilong Huang, Singapore (SG); Qiang Wan, Beijing (CN); Bingyi Kang, Los Angeles, CA (US); Jiashi Feng, Singapore (SG)

(21) Appl. No.: 18/987,418

(22) Filed: Dec. 19, 2024

(30) Foreign Application Priority Data
Dec. 22, 2023 (CN) 202311794444.2

(51) Int. Cl. G06T 11/00; G06N 3/0475; G06N 3/08

(52) U.S. Cl. CPC G06T 11/00; G06N 3/0475; G06N 3/08

(57) ABSTRACT

According to embodiments of the disclosure, a method, an apparatus, a device and a storage medium for image processing are provided. The method includes: obtaining a first feature representation of an input image to be processed; generating, based on the first feature representation and prompt information corresponding to a target visual task, a second feature representation of the input image by using a diffusion model, the prompt information being obtained by training of the diffusion model; and generating, based on the second feature representation, a result of the input image with respect to the target visual task. In this way, on the one hand, the image processing cost is reduced, and on the other hand, the diffusion model can be better adapted to various visual tasks.

### CROSS-REFERENCE

The present application claims priority to Chinese Patent Application No. 202311794444.2, filed on Dec. 22, 2023, and entitled “METHOD, APPARATUS, DEVICE, AND STORAGE MEDIUM FOR IMAGE PROCESSING”, the entirety of which is incorporated by reference.

### FIELD

Example embodiments of the present disclosure generally relate to the field of computers, and more particularly, to a method, an apparatus, a device, and a computer-readable storage medium for image processing.

### BACKGROUND

In the field of computer vision (CV), various image processing technologies based on machine learning have been developed significantly and have been widely used. Computer vision can be applied to a variety of different image processing tasks, such as image generation tasks and visual perception tasks. In visual perception tasks, target images need to be processed to obtain desired perception results, such as classification results, segmentation results, etc.

### SUMMARY

In a first aspect of the present disclosure, an image processing method is provided. The method includes: obtaining a first feature representation of an input image to be processed; generating, based on the first feature representation and prompt information corresponding to a target visual task, a second feature representation of the input image by using a diffusion model, the prompt information being obtained by training of the diffusion model; and generating, based on the second feature representation, a result of the input image with respect to the target visual task.

In a second aspect of the present disclosure, an apparatus for image processing is provided. The apparatus includes: a first representation obtaining module configured to obtain a first feature representation of an input image to be processed; a second representation obtaining module configured to generate, based on the first feature representation and prompt information corresponding to a target visual task, a second feature representation of the input image by using a diffusion model, the prompt information being obtained by training of the diffusion model; and a result generation module configured to generate, based on the second feature representation, a result of the input image with respect to the target visual task.

In a third aspect of the present disclosure, there is provided an electronic device including at least one processing unit; and at least one memory coupled to the at least one processing unit and storing instructions for execution by the at least one processing unit. The instructions, when executed by the at least one processing unit, cause the electronic device to perform the method according to the first aspect.

In a fourth aspect of the present disclosure, there is provided a computer readable storage medium having a computer program stored thereon, and the computer program is executable by a processor to implement the method according to the first aspect.

It should be appreciated that what is described in this Summary is not intended to limit critical features or essential features of embodiments of the disclosure, nor is it intended to limit the scope of the disclosure. Other features of the present disclosure will become readily appreciated from the following description.

### BRIEF DESCRIPTION OF THE DRAWINGS

The above and other features, advantages, and aspects of various embodiments of the present disclosure will become more apparent with reference to the following detailed description taken in conjunction with the accompanying drawings. In the drawings, the same or similar reference numerals denote the same or similar elements, wherein:

FIG. 1 illustrates a schematic diagram of an example environment in which embodiments of the present disclosure can be implemented;

FIG. 2 illustrates a schematic diagram of an image processing architecture for a target visual task according to some embodiments of the present disclosure;

FIG. 3 illustrates a schematic diagram of an image processing flow for a target visual task according to some embodiments of the disclosure;

FIG. 4 illustrates a schematic of converting features of a plurality of scales according to some embodiments of the disclosure;

FIG. 5 illustrates a flowchart of an image processing process according to some embodiments of the disclosure;

FIG. 6 illustrates a block diagram of an apparatus for image processing according to some embodiments of the present disclosure;

FIG. 7 illustrates a block diagram of a device capable of implementing various embodiments of the present disclosure.

### DETAILED DESCRIPTION

It should be understood that, before the technical solutions disclosed in the embodiments of the present disclosure are used, the user should be informed of the type of the personal information, the usage range, the usage scenario, and the like related to the present disclosure in an appropriate manner and the authorization of the user should be obtained according to relevant legal regulations.

For example, in response to receiving an active request from a user, prompt information is sent to the user to explicitly prompt the user that an operation requested by the user will require acquisition and use of personal information of the user. Thus, the user can autonomously select, according to the prompt information, whether to provide personal information to software or hardware such as an electronic device, an application program, a server, or a storage medium that executes the operations of the technical solutions of the present disclosure.

As an optional but non-limiting implementation, in response to receiving an active request of a user, a manner of sending prompt information to the user may be, for example, a manner of a pop-up window, where the pop-up window may present the prompt information in a text manner. In addition, the popup window may also carry a selection control for the user to select ‘agree’ or ‘don't agree’ to provide personal information to the electronic device.

It is to be understood that, the above notification and acquisition of the user authorization process are merely illustrative, and do not limit the implementation of the present disclosure, and other methods meeting relevant legal regulations may also be applied to the implementation of the present disclosure.

It is to be understood that the data involved in the technical solution (including but not limited to the data itself, the acquisition or use of the data) should comply with the requirements of the corresponding legal regulations and related provisions.

Embodiments of the present disclosure will be described in more detail below with reference to the accompanying drawings. Although certain embodiments of the present disclosure are shown in the accompanying drawings, it should be understood that the present disclosure may be implemented in various forms and should not be construed as limited to the embodiments set forth herein, but rather, these embodiments are provided for a thorough and complete understanding of the present disclosure. It should be understood that the drawings and embodiments of the present disclosure are only for illustrative purposes and are not intended to limit the scope of the present disclosure.

It should be noted that the headings of any section/subsection provided herein are not limiting. Various embodiments are described throughout herein, and any type of embodiment can be included under any section/subsection. Furthermore, embodiments described in any section/subsection may be combined in any manner with any other embodiments described in the same section/subsection and/or different sections/subsections.

Herein, unless explicitly stated otherwise, “performing a step in response to A” does not mean that the step is performed immediately after “A”, but may include one or more intermediate steps.

In the description of the embodiments of the present disclosure, the term “including” and the like should be understood as open-ended including, that is, “including but not limited to”. The term “based on” should be read as “based at least in part on.” The term “one embodiment” or “the embodiment” should be read as “at least one embodiment”. The term “some embodiments” should be understood as “at least some embodiments.” Other explicit and implicit definitions may also be included below. The terms “first”, “second”, etc. may refer to different or identical objects. Other explicit and implicit definitions may also be included below.

As used herein, the term “model” may learn associations between corresponding inputs and outputs from training data, such that after training, corresponding output may be generated for given input. The generation of the model may be based on a machine learning technique. Deep learning is a machine learning algorithm that processes inputs and provides corresponding outputs by using a multi-tiered processing unit. A “model” may also be referred to herein as a “machine learning model,” a “machine learning network,” or a “network”, and these terms may be used interchangeably herein. A model may in turn include various types of processing units or networks.

### Example Environment

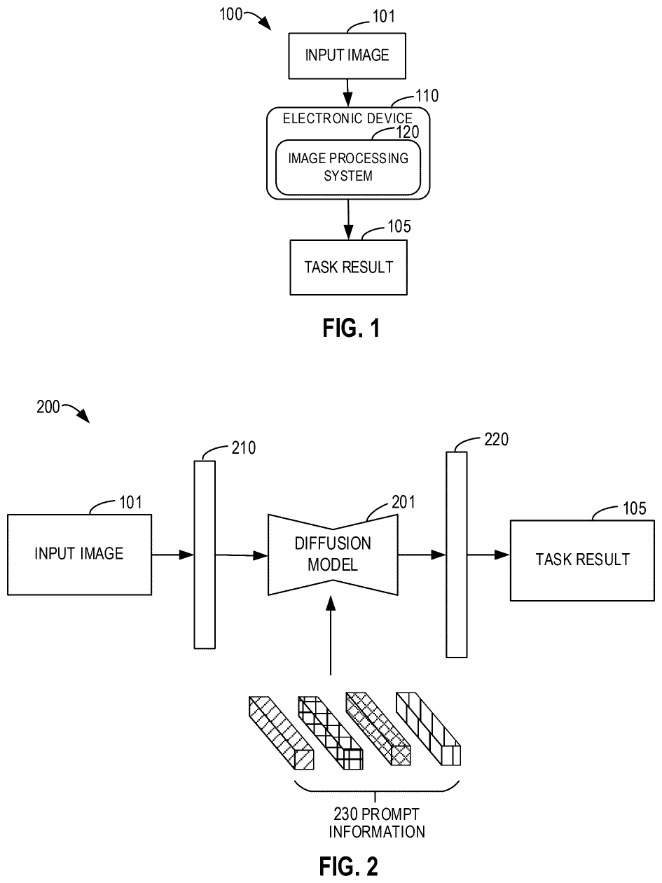

FIG. 1 illustrates a schematic diagram of an example environment 100 in which embodiments of the present disclosure can be implemented. In the environment 100, an image processing system 120, also referred to simply as system 120, is deployed in an electronic device 110. The image processing system 120 is configured to perform a target visual task on the input image 101 to generate a corresponding task result 105.

The target visual task may include any suitable type of visual perception task that performs visual perception on the input image to obtain a corresponding result. Visual perception tasks are non-generative tasks and can include, but are not limited to, image segmentation, image classification, object detection, keypoint detection, depth estimation, and the like. As an example, in the case where the image processing system 120 is used for image classification, the task result 105 may be a classification of an object in the input image 101. As another example, in the case where the image processing system 120 is used for depth estimation, the task result 105 may be a depth map corresponding to the input image 101. It should be appreciated that the visual perception tasks listed above are illustrative only and are not intended to limit the scope of the present disclosure. The image processing system 120 may be applied to any type of perceptual task.

In the environment 100, the electronic device 110 may be any type of device having computing capability, including a terminal device or a server device. The terminal device may be any type of mobile terminal, fixed terminal, or portable terminal including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a positioning device, a television receiver, a radio broadcast receiver, an electronic book device, a game device, or any combination of the foregoing, including accessories and peripherals for these devices, or any combination thereof. A server device may, for example, include a computing system/server, such as a mainframe, an edge computing node, an electronic device in a cloud environment, etc.

It should be appreciated that the structure and functionality of the environment 100 are described for illustrative purposes only and are not intended to imply any limitation on the scope of the disclosure.

As mentioned briefly above, CV techniques have been applied to a variety of image processing tasks, including visual perception tasks. A generative pre-training scheme is one of the technical approaches to achieving general visual perception. Currently, diffusion models have been applied to image generation tasks. By training on massive image-text pair data, the diffusion model enables high quality text-to-image generation. Thus, solutions have been proposed to adapt diffusion models to general visual perception tasks.

However, existing adaptation solutions rely on additional textual information related to the image being processed, such as a class label of an object in the image or a caption of the image, etc. This additional textual information needs to cooperate with the pre-trained textual model to generate a prompt feature. The prompt feature will be used in the diffusion model.

There are problems with such adaptation schemes, for example, relying on additional textual models or the like to generate a prompt feature, which increases the amount of computation. As another example, the generic nature of this adaptation scheme is not sufficient. Visual tasks, such as depth estimation, cannot generate a suitable prompt feature by class labels or explanatory text.

To this end, the embodiments of the present disclosure propose an improved solution for image processing. According to various embodiments of the present disclosure, in a process of executing a target visual task by using a diffusion model, prompt information corresponding to the target visual task is used. Such prompt information is obtained by training a diffusion model. In particular, a second feature representation of the input image is generated by using the diffusion model on the basis of the first feature representation of the input image and the prompt information. A result of the input image in relation to the target visual task is then generated based on the second feature representation.

According to an embodiment of the present disclosure, in performing a visual task using a diffusion model, it is not necessary to rely on an additional text model, but rather prompt information obtained through training of the diffusion model is used. In this way, on the one hand, the image processing cost is reduced, and on the other hand, the diffusion model can be better adapted to various visual tasks.

Some example embodiments of the present disclosure will be described below with continued reference to the accompanying drawings.

### Example Architecture for Target Visual Task

FIG. 2 illustrates a schematic diagram of an image processing architecture 200 for a target visual task according to some embodiments of the present disclosure. The architecture 200 may be implemented by image processing system 120. As shown in FIG. 2, the image processing system 120 may obtain a first feature representation 210 of an input image 101 to be processed. The first feature representation 210 may be considered as a feature of the input image 101 in a latent space. Compared to the input image 101, the first feature representation 210 may be reduced in dimension or compressed. The first feature representation 210 may be generated using any suitable method or machine learning model. Alternatively, the first feature representation 210 may be generated by an external system and input to the image processing system 120. Embodiments of the present disclosure are not limited in this regard.

The image processing system 120 may also include or utilize prompt information 230 corresponding to the target visual task. In particular, the image processing system 120 may generate a second feature representation 220 of the input image 101 using the diffusion model 201 based on the prompt information 230 and the first feature representation 210. The prompt information 230 is obtained by training of the diffusion model 201. In particular, the prompt information 230 may be determined by training of the diffusion model 201 for the target visual task and may be considered as a description of the target visual task. The diffusion model 201 may be pretrained and tuned for the target visual task.

The prompt information 230 may be implemented in any suitable manner. In some embodiments, the prompt information 230 may include a plurality of prompt representations at the same dimension. For example, the prompt information 230 may include a plurality of embedded representations, also referred to as meta-prompts. These meta-prompts are incorporated into the diffusion model 201. Illustratively, the prompt information 230 can be represented as M_{ϕ}∈z,21 ^{N×D}, where N represents the number of meta-prompts, and D represents the dimension of the meta-prompts. In some embodiments, the number of prompt representations (e.g., the value of N) may be associated with the target visual task. That is, the number of prompt representations may be set according to the particular visual task.

Such prompt information 230 may be used to mimic text embedding. With the prompting information 230, extraneous textual prompts (such as class labels, image caption text, etc.), are no longer necessary for the diffusion model 201, and the use of pre-trained text encoders is also avoided.

Such prompt information 230 is learnable that learns, and adapts a particular target visual task, as the diffusion model 201 is trained. For example, the diffusion model 201 and the prompt information 230 may be trained end-to-end in accordance with the target visual task and the corresponding dataset, thereby constructing the prompt information 230 tailored to the diffusion model 201 and the target visual task.

In some embodiments, in the training phase, an initial prompt representation may be generated for the prompt information, e.g., the prompt information may be initialized at random. The training loss for the target visual task may be determined using the diffusion model based on the initial prompt representation, and the diffusion model and the initial prompt representation are updated based on the training loss until a predetermined condition is met. For example, the diffusion model 201 and the prompt representation may be updated by minimizing the training loss until the training loss is less than a predetermined threshold or until a predetermined number of training rounds are reached. As such, the updated initial prompt representation may be determined as the prompt information 230.

Upon initialization, the prompt information (such as with a random value) may not possess any meaningful information about the target visual task. With the training process, the prompt information undergoes a transformation process. Through iterative updates during training, the prompt information evolves from meaningless noise to valuable semantic information related to the target visual task. Accordingly, such prompt information 230 obtained by training of the diffusion model 201 for the target visual task may be considered as containing rich and task-specific semantic information.

Depending on the specific structure of the diffusion model 201, the diffusion model 201 may combine the first feature representation 210 with the prompt information 230 in any suitable manner. In some embodiments, the diffusion model 201 may be based on a cross-attention mechanism, such as a denoising U-type network. In such embodiments, cross-attention may be applied to the first feature representation 210 (or the transformed first feature representation 210) and the prompt information 230 through the diffusion model 201 to obtain an attention map. The diffusion model 201 may then determine the second feature representation 220 based on the attention. The diffusion model 201 may be configured to have any suitable network structure to apply cross-attention, and the embodiments of the present disclosure are not limited in this regard.

In such an embodiment, the first feature representation 210 is an image feature, and the prompt information 230 as a semantic feature may enable a cross-modal fusion with the image feature through a cross-attention mechanism. As an alternative to text embedding, such prompt information 230 may eliminate differences between the diffusion model of text to image type and the visual perception task.

Continuing with the architecture 200, the image processing system 120 may, in turn, generate a task result 105 for the target visual task based on the second feature representation 220 of the input image 101. For example, the second feature representation 220 or the transformed second feature representation 220 may be fed into a decoder for the target visual task to obtain the task result 105.

The example image processing architecture for the target visual task is described above. With the prompt information determined through training the diffusion model, the gap between the generative model and the non-generative visual perception tasks can be bridged without the need for additional textual information. Thus, the diffusion model can be adapted to various visual perception tasks. In this manner, embodiments of the present disclosure implement a generalized approach for visual perception.

### Multi-Scale Feature Reconstruction

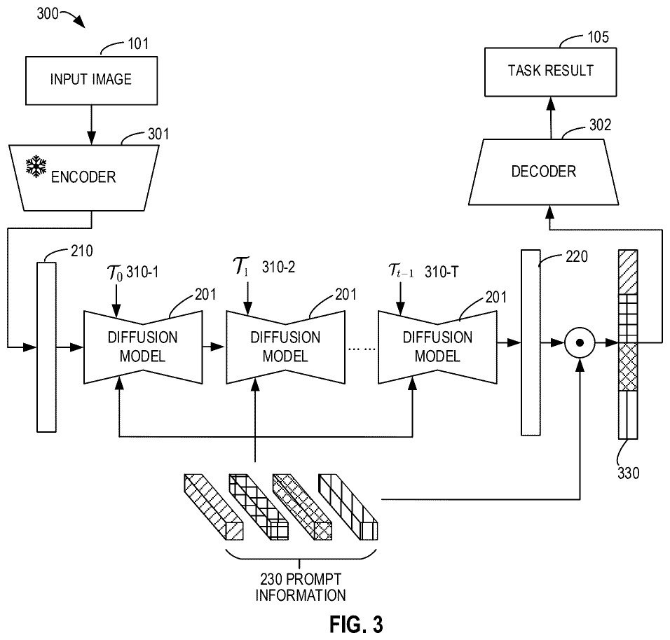

FIG. 3 illustrates a schematic diagram of an image processing flow 300 for a target visual task according to some embodiments of the disclosure. The image processing flow 300 may be considered an example flow implemented by the image processing system 120.

As shown in FIG. 3, the encoder 301 may generate a first feature representation 210 of the input image 101 based on the input image 101. For example, the encoder 301 may perform image compression on the input image 101 to reduce the resolution of input image 101, resulting in feature representation in the latent space. The encoder 301 may be implemented in any suitable network structure. As one example, a variational auto-encoder (VAE), such as a vector quantized variational auto-encoder (VQVAE), may be utilized. It should be understood, however, that this is merely illustrative and is not intended to be limiting. The encoder 302 may have any suitable network structure.

In some embodiments, the encoder 301 may be cured. In other words, the encoder 301 may not be trained together with the diffusion model 201. Thus, encoder 301 may be implemented with any general-purpose encoding model or image feature extraction model.

Next, the generation of the second feature representation 220 may be based on the first feature representation 210 and the prompt information 230. In some embodiments, the generation of the second feature representation 220 may include a plurality of steps, e.g., t steps as shown in FIG. 3, where t is a positive integer. By way of example, the generation of the second feature representation 220 may include 3 steps. Note that compared to the diffusion model being used for image generation, the required steps are greatly reduced in the case of diffusion model being used for visual perception tasks.

The prompt information 230 is fed to the diffusion model 201 in each step. For example, in each step, the image processing system 120 may determine, based on first feature representation 201 (for the first step) or a previous step to the step (for a step subsequent to the first step), an input feature representation of this step. The image processing system 120 may then generate an output feature representation of a step from the input feature representation of the step by taking the prompt information 230 as at least part of the condition of the diffusion model 201. If this step is the last step, the generated output feature representation may be used as the second feature representation 220. If this step is not the last step, the generated output feature representation may be used in the next step as an input feature representation for the diffusion model 201.

The second feature representation 220 may be generated by a process as described above. In some embodiments, valuable semantic information embodied by the prompt information 230 may further be utilized. As shown in FIG. 3, the image processing system 120 may utilize the prompt information 230 to convert the second feature representation 220, to obtain a converted feature representation 330. This conversion of the second feature representation may be considered a feature rearrangement such that the converted feature representation is more relevant to the target visual task.

In some embodiments, the second feature representation 220 may include features of a plurality of scales depending on the specific structure of the diffusion model 201. For example, features near the output layer focus mainly on finer, low-level details. In some cases, such low-level details are not sufficient for visual perception tasks that emphasize texture and granularity, and some visual perception tasks may require an understanding of low level details and high level semantics.

In view of this, the features of a plurality of scales may be combined to generate a converted feature representation 330. By way of example, the image processing system 120 may convert the features of these scales respectively by using the prompt information 230, so as to obtain converted features of a plurality of scales, and may combine the converted features of the plurality of scales into a converted feature representation 330.

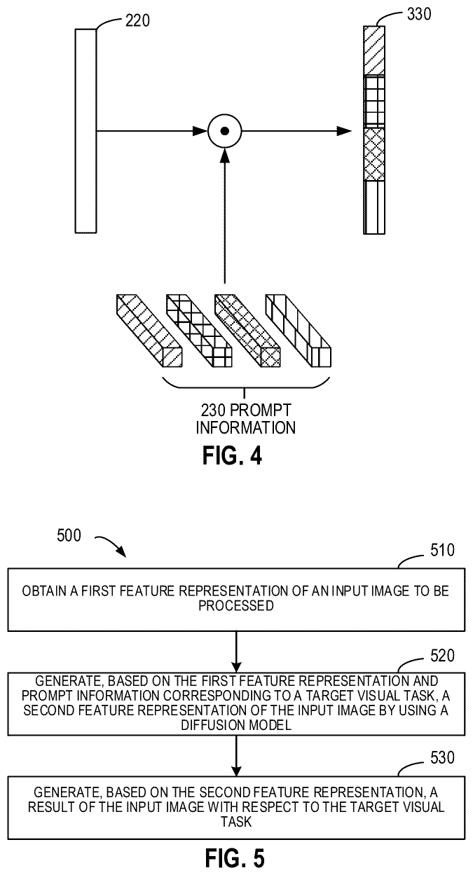

An example is described with reference to FIG. 4. The features of a plurality of scales may be represented by {Fᵢ}ᵢ₌₁⁴, where Fᵢ∈ [symbol] ^{D×H×W}, H and W represent the height and width of the feature map respectively. This example includes the features of 4 dimensions, but this is exemplary only and is not intended to be limiting. The prompt information 230 may be represented by M_{ϕ}∈ [symbol] ^{N×D}, as described with reference to FIG. 2. Accordingly, the converted feature {Rᵢ}ᵢ₌₁⁴ at each scale may be derived by:

$$\begin{matrix}{R}_{i} = {ℳ}_{ϕ} \cdot {F}_{i} \\ = {ℝ}^{N \times D} \cdot {ℝ}^{D \times H \times W} \\ = {ℝ}^{N \times H \times W}\end{matrix} , i = 1 , 2 , 3 , 4 \qquad ( 1 )$$

The features of a plurality of scales are combined with the task adaptation feature of the prompt information through a dot product operation between meta-prompts and feature maps at various scales.

As described above, the prompt information is adapted to the task, and embedded with contextual knowledge of the data set specific to the target visual task. This context perceptibility enables the prompt information to be used as a filter, leading the feature reconstruction process described above to find the features most relevant to the target visual task from the features generated by the diffusion model.

With continued reference to FIG. 3, the image processing system 120 may then utilize the decoder 302 to determine the task result 105 based on the transformed feature representation 330. For example, for a depth estimation task, the task result 105 may include an estimated depth map. As another example, for an image segmentation task, the task result 105 may include a separation mask. The decoder 302 is specific to the target visual task. For example, the decoder 302 may be trained with the diffusion model 201 for the target visual task. The decoder 302 may have any suitable structure, and embodiments of the present disclosure are not limited in this regard.

### Multistep Modulation

As described above, in some embodiments, the generation of the second feature representation 220 may include a plurality of steps. The output of the diffusion model 201 in one step may be used as input to the diffusion model 201 in the next step. In some cases, there may be challenges to doing so. As these steps proceed, the distribution of input features may experience an offset. However, the parameters of the diffusion model 201 remain the same in different steps.

To this end, in some embodiments, in each of these steps, a learnable model modulation information may be used. In the example of FIG. 2, model modulation information 310-1, 310-2, . . . , 310-t (denoted by [symbol] , [symbol] and [symbol] respectively) are shown for the t steps, also referred to collectively or individually as model modulation information 310. Exemplarily, the model modulation information 310 may be used as a time step coding of the diffusion model 201 in a corresponding step. In the example of FIG. 2, in each step, an output feature representation is generated from the input feature representation by taking the prompt information 230 as a condition and taking the model modulation information as a time step coding.

The model modulation information 310 in different steps may be different, depending on the training of the diffusion model 201. The model modulation information 310 may be a time step embedding used to adjust the parameters of the diffusion model 201.

The model modulation information is learnable, and it adapts changes in input features as the diffusion model 201 is trained. For example, the diffusion model 201, the prompt information 230 and the model modulation information 310 may be trained end-to-end according to the target visual task and the corresponding dataset.

In some embodiments, during the training phase, an initial modulation representation for the model modulation information may be generated, e.g., the model modulation information for each step may be initialized randomly. The training loss for the target visual task may be determined using a diffusion model based on the initial prompt representation and the initial modulation representation, and the diffusion model, the initial prompt representation and the initial modulation representation are updated based on the training loss until a predetermined condition is met. For example, the diffusion model 201, the initial prompt representation, and the initial modulation representation may be updated by minimizing the training loss, until the training loss is less than a predetermined threshold or a predetermined number of training rounds is reached. As such, the updated initial modulation representation may be determined as the model modulation information 310.

With the model modulation information, it can be ensured that the diffusion model 201 remains adaptative and responsive to a changing property of an input feature in different steps, thereby optimizing a feature extraction process and enhancing the performance of the diffusion model in a visual perception task.

### Example Processes

FIG. 5 shows a flowchart of a process 500 for image processing according to some embodiments of the present disclosure. The process 500 may be implemented at electronic device 110, e.g., may be implemented by image processing system 120.

At block 510, the image processing system 120 obtains a first feature representation of an input image to be processed.

In block 520, the image processing system 120 generates a second feature representation of the input image using the diffusion model based on the first feature representation and the prompt information corresponding to a target visual task. The prompt information is obtained by training of a diffusion model.

At block 530, the image processing system 120 generates, based on second feature representation, a result of the input image with respect to the target visual task.

In some embodiments, generating the result of the input image with respect to the target visual task includes: converting the second feature representation by using the prompt information to obtain a converted second feature representation; and determining the result by using a decoder for the target visual task based on the converted second feature representation.

In some embodiments, the second feature representation includes features of a plurality of scales, and obtaining the converted second feature representation includes: respectively converting the features of the plurality of scales by using the prompt information, so as to obtain converted features of the plurality of scales; and combining the converted features of the plurality of scales into the converted second feature representation.

In some embodiments, the decoder is trained together with a diffusion model for the target visual task.

In some embodiments, generating the second feature representation of the input image includes a plurality of steps, and a given step of the plurality of steps includes: determining an input feature representation of the given step based on the first feature representation or an output of a previous step of the given step; and generating, by using the diffusion model, an output feature representation of the given step from the input feature representation by taking the prompt information as a condition.

In some embodiments, generating the output feature representation for the given step includes generating, by using the diffusion model, the output feature representation from the input feature representation by taking the prompt information as a condition and taking model modulation information for the given step as a time step coding, wherein the model modulation information is obtained by training of the diffusion model.

In some embodiments, the prompt information is obtained by generating an initial prompt representation for the prompt information; determining, based on the initial prompt representation, a training loss for the target visual task by using the diffusion model; updating the diffusion model and the initial prompt representation based on the training loss until a predetermined condition is met; and determining the updated initial prompt representation as the prompt information.

In some embodiments, generating the second feature representation of the input image includes a plurality of steps, and in a given step in the plurality of steps, the model modulation information is taken as a time step coding of the diffusion model, and the model modulation information is obtained by: generating an initial modulation representation for the model modulation information; determining the training loss by using the diffusion model based on the initial prompt representation and the initial modulation representation; updating the diffusion model, the initial coding representation, and the initial modulation representation based on the training loss until the predetermined condition is met; and determining an updated initial modulation representation as the model modulation information.

In some embodiments, generating the second feature representation of the input image includes: applying cross-attention to the first feature representation and the prompt information to obtain an attention map; and determining the second feature representation based on the attention map.

In some embodiments, the prompt information includes a plurality of prompt representations having the same dimension, and the number of the plurality of prompt representations is associated with the target visual task.

### Example Apparatus and Device

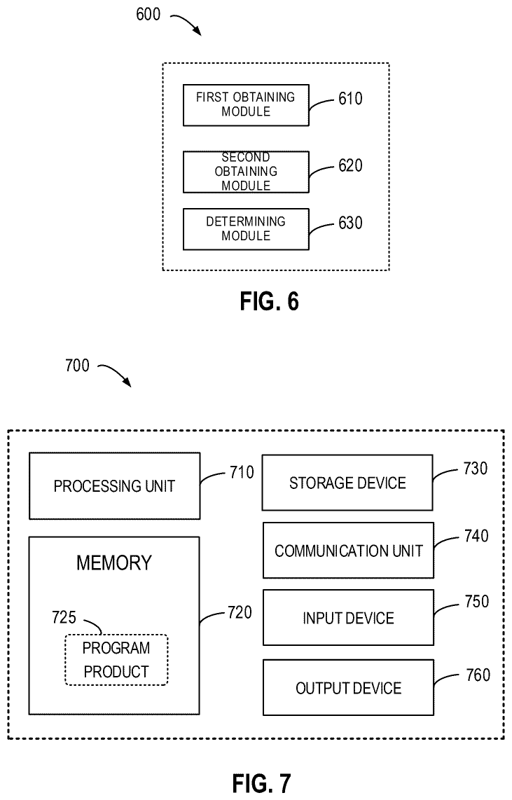

FIG. 6 shows a schematic structural block diagram of an apparatus 600 for image processing, in accordance with certain embodiments of the present disclosure. The apparatus 600 may be implemented as or included in an electronic device 110, such as an image processing system 120. The various modules/components in apparatus 600 may be implemented by hardware, software, firmware, or any combination thereof.

As shown, the apparatus 600 includes a first representation obtaining module 610 configured to obtain a first feature representation of an input image to be processed. The apparatus 600 further includes a second representation acquisition module 620, configured to generate a second feature representation of the input image by using a diffusion model based on the first feature representation and prompt information corresponding to a target visual task, wherein the prompt information is obtained by training of the diffusion model. The apparatus 600 further includes a result generation module 630 configured to generate, based on the second feature representation, a result of the input image with respect to the target visual task.

In some embodiments, the result generation module 630 includes: a feature conversion module configured to obtain a converted second feature representation by converting the second feature representation utilizing the prompt information; and a decoding module configured to, based on the converted second feature representation, determine an outcome using a decoder for the target visual task.

In some embodiments, the second feature representation includes features of multiple scales, and the feature conversion module is further configured to: convert, with the prompt information, the features of the multiple scales, respectively, to obtain converted features of the multiple scales; and combine the converted features of the multiple scales into a converted second feature representation.

In some embodiments, the decoder is trained with a diffusion model for the target visual task.

In some embodiments, generating the second feature representation of the input image includes a plurality of steps, and the second representation obtaining module 620 is further configured to: in a given step in the plurality of steps, determine an input feature representation of the given step based on the first feature representation or an output of a previous step of the given step; and generate, by using the diffusion model, an output feature representation of the given step from the input feature representation by taking the prompt information as a condition.

In some embodiments, the second representation obtaining module 620 is further configured to generate, by using the diffusion model, the output feature representation from the input feature representation by taking the prompt information as a condition and taking model modulation information for the given step as a time step coding, wherein the model modulation information is obtained by training of the diffusion model.

In some embodiments, the apparatus 600 further includes a prompt information obtaining module configured to obtain prompt information by generating an initial prompt representation for the prompt information; determining, based on the initial prompt representation, a training loss for the target visual task by using the diffusion model; updating the diffusion model and the initial prompt representation based on the training loss until a predetermined condition is met; and determining the updated initial prompt representation as the prompt information.

In some embodiments, generating the second feature representation of the input image includes a plurality of steps, and in a given step in the plurality of steps, the model modulation information is taken as a time step coding of the diffusion model, and the apparatus 600 further includes a modulation information obtaining module configured to obtain the model modulation information by: generating an initial modulation representation for the model modulation information; determining the training loss by using the diffusion model based on the initial prompt representation and the initial modulation representation; updating the diffusion model, the initial coding representation, and the initial modulation representation based on the training loss until the predetermined condition is met; and determining an updated initial modulation representation as the model modulation information.

In some embodiments, the second representation acquisition module 620 is further configured to: apply cross-attention to the first feature representation and the prompt information to obtain an attention map; and determine the second feature representation based on the attention map.

In some embodiments, the prompt information includes a plurality of prompt representations having the same dimension, and the number of the plurality of prompt representations is associated with the target visual task.

FIG. 7 illustrates a block diagram of an electronic device 700 in which one or more embodiments of the present disclosure may be implemented. It should be appreciated that the electronic device 700 shown in FIG. 7 is merely exemplary and should not constitute any limitation on the functionality and scope of the embodiments described herein. The electronic device 700 shown in FIG. 7 may be used to implement the electronic device 110 of FIG. 1.

As shown in FIG. 7, the electronic device 700 is in the form of a general-purpose electronic device. Components of the electronic device 700 may include, but are not limited to, one or more processors or processing units 710, a memory 720, a storage device 730, one or more communications units 740, one or more input devices 750, and one or more output devices 760. The processing unit 710 may be an actual or virtual processor and can perform various processes according to programs stored in the memory 720. In a multiprocessor system, a plurality of processing units executes computer executable instructions in parallel, so as to improve the parallel processing capability of the electronic device 700.

The electronic device 700 typically includes a number of computer storage media. Such media may be any available media that are accessible by electronic device 700, including, but not limited to, volatile and non-volatile media, removable and non-removable media. The memory 720 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 730 may be a removable or non-removable medium and may include a machine-readable medium such as a flash drive, a magnetic disk, or any other medium that can be used to store information and/or data and that can be accessed within the electronic device 1200.

The electronic device 700 may further include additional removable/non-removable, volatile/nonvolatile storage media. Although not shown in FIG. 7, a magnetic disk drive for reading from or writing to a removable, nonvolatile magnetic disk such as a “floppy disk” and an optical disk drive for reading from or writing to a removable, nonvolatile optical disk may be provided. In these cases, each drive may be connected to a bus (not shown) by one or more data media interfaces. The memory 720 may include a computer program product 725 having one or more program modules configured to perform various methods or actions of various embodiments of the present disclosure.

The communication unit 740 implements communication with other electronic devices through a communication medium. In addition, functions of components of the electronic device 700 may be implemented by a single computing cluster or a plurality of computing machines, and these computing machines can communicate through a communication connection. Thus, the electronic device 700 may operate in a networked environment using logical connections to one or more other servers, network personal computers (PCs), or another network node.

The input device 750 may be one or more input devices such as a mouse, keyboard, trackball, etc. The output device 760 may be one or more output devices such as a display, speaker, printer, etc. The electronic device 700 may also communicate with one or more external devices (not shown) such as a storage device, a display device, or the like through the communication unit 740 as required, and communicate with one or more devices that enable a user to interact with the electronic device 700, or communicate with any device (e.g., a network card, a modem, or the like) that enables the electronic device 700 to communicate with one or more other electronic devices. Such communication may be performed via an input/output (I/O) interface (not shown).

According to an exemplary implementation of the present disclosure, a computer readable storage medium is provided, on which a computer-executable instruction is stored, wherein the computer executable instruction is executed by a processor to implement the above-described method. According to an exemplary implementation of the present disclosure, there is also provided a computer program product, which is tangibly stored on a non-transitory computer readable medium and includes computer-executable instructions that are executed by a processor to implement the method described above.

Aspects of the present disclosure are described herein with reference to flowchart and/or block diagrams of methods, apparatus, devices, and computer program products implemented in accordance with the present disclosure. It will be understood that each block of the flowcharts and/or block diagrams and combinations of blocks in the flowchart and/or block diagrams can be implemented by computer readable program instructions.

These computer readable program instructions may be provided to a processing unit of a general-purpose computer, special purpose computer, or other programmable data processing apparatus to produce a machine, such that the instructions, which execute via the processing unit of the computer or other programmable data processing apparatus, create means for implementing the functions/actions specified in one or more blocks of the flowchart and/or block diagrams. These computer readable program instructions may also be stored in a computer readable storage medium that can direct a computer, a programmable data processing apparatus, and/or other devices to function in a particular manner, such that the computer readable medium storing the instructions includes an article of manufacture including instructions which implement various aspects of the functions/actions specified in one or more blocks of the flowchart and/or block diagrams.

The computer readable program instructions may be loaded onto a computer, other programmable data processing apparatus, or other devices, causing a series of operational steps to be performed on a computer, other programmable data processing apparatus, or other devices, to produce a computer implemented process such that the instructions, when executed on the computer, other programmable data processing apparatus, or other devices, implement the functions/actions specified in one or more blocks of the flowchart and/or block diagrams.

The flowcharts and block diagrams in the drawings illustrate the architecture, functionality, and operations of possible implementations of the systems, methods, and computer program products according to various implementations of the present disclosure. In this regard, each block in the flowchart or block diagram may represent a module, segment, or portion of instructions which includes one or more executable instructions for implementing the specified logical function(s). In some alternative implementations, the functions marked in the blocks may occur in a different order than those marked in the drawings. For example, two consecutive blocks may actually be executed in parallel, or they may sometimes be executed in reverse order, depending on the function involved. It should also be noted that each block in the block diagrams and/or flowcharts, as well as combinations of blocks in the block diagrams and/or flowcharts, may be implemented using a dedicated hardware-based system that performs the specified function or operations, or may be implemented using a combination of dedicated hardware and computer instructions.

Various implementations of the disclosure have been described as above, the foregoing description is exemplary, not exhaustive, and the present application is not limited to the implementations as disclosed. Many modifications and variations will be apparent to those of ordinary skill in the art without departing from the scope and spirit of the implementations as described. The selection of terms used herein is intended to best explain the principles of the implementations, the practical application, or improvements to technologies in the marketplace, or to enable those skilled in the art to understand the implementations disclosed herein

What is claimed is:

1. A method for image processing, comprising:
obtaining a first feature representation of an input image to be processed;
generating, based on the first feature representation and prompt information corresponding to a target visual task, a second feature representation of the input image by using a diffusion model, the prompt information being obtained by training of the diffusion model; and
generating, based on the second feature representation, a result of the input image with respect to the target visual task.

2. The method of claim 1, wherein generating the result of the input image with respect to the target visual task comprises:
converting the second feature representation by using the prompt information, to obtain a converted second feature representation; and
determining, based on the converted second feature representation, the result by using a decoder for the target visual task.

3. The method of claim 2, wherein the second feature representation comprises features of a plurality of scale, and obtaining the converted second feature representation comprises:
respectively converting the features of the plurality of scales by using the prompt information, to obtain converted features of the plurality of scales; and
combining the converted features of the plurality of scales into the converted second feature representation.

4. The method of claim 2, wherein the decoder is trained together with the diffusion model for the target visual task.

5. The method of claim 1, wherein generating the second feature representation of the input image comprises a plurality of steps, and a given step in the plurality of steps comprises:
determining an input feature representation of the given step based on the first feature representation or an output of a previous step of the given step; and
generating, by using the diffusion model, an output feature representation of the given step from the input feature representation by taking the prompt information as a condition.

6. The method of claim 5, wherein generating the output feature representation of the given step comprises:
generating, by using the diffusion model, the output feature representation from the input feature representation by taking the prompt information as a condition and taking model modulation information for the given step as a time step coding, wherein the model modulation information is obtained by training of the diffusion model.

7. The method of claim 1, wherein the prompt information is obtained by the following:
generating an initial prompt representation for the prompt information;
determining, based on the initial prompt representation, a training loss for the target visual task by using the diffusion model;
updating the diffusion model and the initial prompt representation based on the training loss, until a predetermined condition is met; and
determining the updated initial prompt representation as the prompt information.

8. The method of claim 7, wherein generating the second feature representation of the input image comprises a plurality of steps, and in a given step in the plurality of steps, model modulation information is taken as a time step coding of the diffusion model, and the model modulation information is obtained by:
generating an initial modulation representation for the model modulation information;
determining, by using the diffusion model, the training loss based on the initial prompt representation and the initial modulation representation;
updating the diffusion model, the initial coding representation, and the initial modulation representation based on the training loss, until the predetermined condition is met; and
determining the updated initial modulation representation as the model modulation information.

9. The method of claim 1, wherein generating the second feature representation of the input image comprises:
applying cross-attention to the first feature representation and the prompt information to obtain an attention map; and
determining the second feature representation based on the attention map.

10. The method of claim 1, wherein the prompt information comprises a plurality of prompt representations having the same dimension, and the number of the plurality of prompt representations is associated with the target visual task.

11. An electronic device, comprising:
at least one processing unit;
at least one memory coupled to the at least one processing unit and storing instructions for execution by the at least one processing unit, wherein the instructions, when executed by the at least one processing unit, cause the electronic device to perform at least:
obtaining a first feature representation of an input image to be processed;
generating, based on the first feature representation and prompt information corresponding to a target visual task, a second feature representation of the input image by using a diffusion model, the prompt information being obtained by training of the diffusion model; and
generating, based on the second feature representation, a result of the input image with respect to the target visual task.

12. The electronic device of claim 11, wherein generating the result of the input image with respect to the target visual task comprises:
converting the second feature representation by using the prompt information, to obtain a converted second feature representation; and
determining, based on the converted second feature representation, the result by using a decoder for the target visual task.

13. The electronic device of claim 12, wherein the second feature representation comprises features of a plurality of scale, and obtaining the converted second feature representation comprises:
respectively converting the features of the plurality of scales by using the prompt information, to obtain converted features of the plurality of scales; and
combining the converted features of the plurality of scales into the converted second feature representation.

14. The electronic device of claim 12, wherein the decoder is trained together with the diffusion model for the target visual task.

15. The electronic device of claim 11, wherein generating the second feature representation of the input image comprises a plurality of steps, and a given step in the plurality of steps comprises:
determining an input feature representation of the given step based on the first feature representation or an output of a previous step of the given step; and
generating, by using the diffusion model, an output feature representation of the given step from the input feature representation by taking the prompt information as a condition.

16. The electronic device of claim 15, wherein generating the output feature representation of the given step comprises:
generating, by using the diffusion model, the output feature representation from the input feature representation by taking the prompt information as a condition and taking model modulation information for the given step as a time step coding, wherein the model modulation information is obtained by training of the diffusion model.

17. The electronic device of claim 11, wherein the prompt information is obtained by the following:
generating an initial prompt representation for the prompt information;
determining, based on the initial prompt representation, a training loss for the target visual task by using the diffusion model;
updating the diffusion model and the initial prompt representation based on the training loss, until a predetermined condition is met; and
determining the updated initial prompt representation as the prompt information.

18. The electronic device of claim 17, wherein generating the second feature representation of the input image comprises a plurality of steps, and in a given step in the plurality of steps, model modulation information is taken as a time step coding of the diffusion model, and the model modulation information is obtained by:
generating an initial modulation representation for the model modulation information;
determining, by using the diffusion model, the training loss based on the initial prompt representation and the initial modulation representation;
updating the diffusion model, the initial coding representation, and the initial modulation representation based on the training loss, until the predetermined condition is met; and
determining the updated initial modulation representation as the model modulation information.

19. The electronic device of claim 11, wherein generating the second feature representation of the input image comprises:
applying cross-attention to the first feature representation and the prompt information to obtain an attention map; and
determining the second feature representation based on the attention map.

20. A non-transitory computer readable storage medium having a computer program stored thereon, wherein the computer program is executable by a processor to implement at least:
obtaining a first feature representation of an input image to be processed;
generating, based on the first feature representation and prompt information corresponding to a target visual task, a second feature representation of the input image by using a diffusion model, the prompt information being obtained by training of the diffusion model; and
generating, based on the second feature representation, a result of the input image with respect to the target visual task.
